(19) United States
(12) Patent Application Publication
(10) Pub. No.: US 2004/0115451 A1
(43) Pub. Date: Jun. 17, 2004

(54) Yellowing prevention of cellulose-based consumer products

(75) Inventors: Werner Franz Wilhelm Lonsky, Appleton, WI (US); William Hung Nguyen, Appleton, WI (US); Kevin Bradley Sartain, Broken Arrow, OK (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/729,470

(22) Filed: Dec. 5, 2003

Related U.S. Application Data
(63) Continuation-in-part of application No. 10/315,697, filed on Dec. 9, 2002.
(60) Provisional application No. 60/479,719, filed on Jun. 18, 2003.

(51) Int. Cl. B32B 27/06

(52) U.S. Cl. 428/480

(57) ABSTRACT

The present invention is a consumer product packaging system comprising at least one consumer product wrapped in a UV—protective thermoplastic packaging film. At least one of the consumer products wrapped in the UV—protective thermoplastic packaging film has a brightness value wherein the brightness value of the consumer product changes about 5 percent or less during an exposure to light for a period of about 12 months or more.

This application is a continuation-in-part application of U.S. Ser. No. 10/315,697 filed Dec. 9, 2002 and claims the benefits of U.S. Provisional Application No. 60/479,719 filed Jun. 18, 2003.

### BACKGROUND OF THE INVENTION

Cellulose-based consumer products, such as facial tissues, paper towels, napkins, and bath tissue, are typically wrapped in a thermoplastic packaging film. The thermoplastic packaging film may be used to wrap individual units of the consumer products and/or multi-units of consumer products. The thermoplastic packaging film may also be used to wrap multiple packages of consumer products. Such thermoplastic packaging film may also be used to hold stacked packaged consumer products, such as on a pallet. In other packaging using the thermoplastic packaging film, only a portion, such as a window element, may comprise the thermoplastic packaging film. One advantage of such packaging that incorporates thermoplastic packaging film is that the customer and/or the consumer may view the consumer products contained within.

Thermoplastic packaging film is typically clear or otherwise light permeable. Exposure of cellulose-based consumer products to light, natural or artificial, may alter the consumer products. Cellulose-based consumer products, especially such consumer products that comprise BCTMP fibers, are particularly sensitive to light. Cellulose-based consumer products change color, typically ranging from a yellowish to brownish hue, upon exposure to light, especially light rays in UV wavelengths. Exposure may be from direct or diffuse light. Exposure may occur at any point during shipping and/or storage of such packaged consumer products, including the time the consumer products are displayed on store shelves.

Some thermoplastic packaging film has been developed which have UV-absorbing or deflecting characteristics. Some such thermoplastic packaging film may comprise inorganic compounds such as metal oxides. Examples of the metal oxides include titanium dioxide (TiO₂) and zinc oxide (ZnO). The thermoplastic packaging films comprising the inorganic compounds typically deflect the light, thereby reducing or preventing exposure of the consumer products contained within the packaging comprised at least in part by the thermoplastic packaging film. The higher the content of the inorganic compounds per unit area in the thermoplastic packaging film or at a given thickness of the thermoplastic packaging film, the more effective the thermoplastic packaging film is reducing or preventing the light exposure of the consumer product. Thermoplastic packaging films comprising inorganic compounds typically have an opaque white haze or coloration which becomes more pronounced as the inorganic compound content increases. This opaque white haze or coloration may interfere with the customer's and/or consumer's view of the consumer products contained within the packaging comprising the thermoplastic packaging film.

Other thermoplastic packaging films have been treated with yellow pigments to provide protection against the violet portion of visible light. The yellow pigments may be contained within the thermoplastic packaging films or applied to at least one surface of the thermoplastic packaging films. However, in some uses of the thermoplastic packaging films, it is desirable for the thermoplastic packaging films to be clear and colorless, especially when the consumer products may be of different colors.

Other thermoplastic packaging films have been treated with organic compounds, typically polar, having UV-absorbing characteristics. Examples of such organic compounds include benzotriazoles and benzophenones.

### SUMMARY OF THE INVENTION

One embodiment of the present invention is a consumer product packaging system comprising at least one consumer product wrapped in an UV-protective thermoplastic packaging film. The consumer product, wrapped in the UV-protective thermoplastic packaging film, has a brightness value wherein the brightness value of the consumer product changes about 5 percent or less during an exposure to light for a period of about 12 months or more.

Another embodiment of the present invention is a consumer product packaging system comprising at least one consumer product wrapped in an UV-protective thermoplastic packaging film. The consumer product, wrapped in the UV-protective thermoplastic packaging film, has a b-value wherein the b-value of the consumer product changes about 20 percent or less during an exposure to light for a period of about 12 months or more.

### BRIEF DESCRIPTION OF THE DRAWING

FIG. 1 is a schematic of a papermaking apparatus.

### DETAILED DESCRIPTION OF THE INVENTION

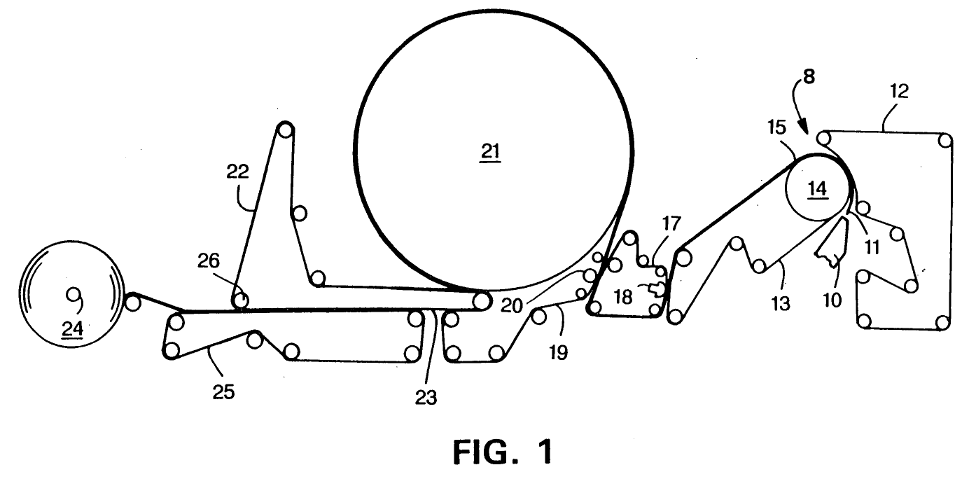

Referring to FIG. 1, a process of carrying out using the present invention will be described in greater detail. The process shown depicts an uncreped through dried process, but it will be recognized that any known papermaking method or tissue making method can be used in conjunction with the non-woven tissue making fabrics of the present invention. Related uncreped through air dried tissue processes are described in U.S. Pat. No. 5,656,132 issued on Aug. 12, 1997 to Farrington et al. and in U.S. Pat. No. 6,017,417 issued on Jan. 25, 2000 to Wendt et al. Both patents are herein incorporated by reference to the extent they are not contradictory herewith. Exemplary methods for the production of creped tissue and other paper products are disclosed in U.S. Pat. No. 5,855,739, issued on Jan. 5, 1999 to Ampulski et al.; U.S. Pat. No. 5,897,745, issued on Apr. 27, 1999 to Ampulski et al.; U.S. Pat. No. 5,893,965, issued on Apr. 13, 1999 to Trokhan et al.; U.S. Pat. No. 5,972,813 issued on Oct. 26, 1999 to Polat et al.; U.S. Pat. No. 5,503,715, issued on Apr. 2, 1996 to Trokhan et al.; U.S. Pat. No. 5,935,381, issued on Aug. 10, 1999 to Trokhan et al.; U.S. Pat. No. 4,529,480, issued on Jul. 16, 1985 to Trokhan; U.S. Pat. No. 4,514,345, issued on Apr. 30, 1985 to Johnson et al.; U.S. Pat. No. 4,528,239, issued on Jul. 9, 1985 to Trokhan; U.S. Pat. No. 5,098,522, issued on Mar. 24, 1992 to Smurkoski et al.; U.S. Pat. No. 5,260,171, issued on Nov. 9, 1993 to Smurkoski et al.; U.S. Pat. No. 5,275,700, issued on Jan. 4, 1994 to Trokhan; U.S. Pat. No. 5,328,565, issued on Jul. 12, 1994 to Rasch et al.; U.S. Pat. No. 5,334,289, issued on Aug. 2, 1994 to Trokhan et al.; U.S. Pat. No. 5,431,786, issued on Jul. 11, 1995 to Rasch et al.; U.S. Pat. No. 5,496,624, issued on Mar. 5, 1996 to Stelljes, Jr. et al.; U.S. Pat. No. 5,500,277, issued on Mar. 19, 1996 to Trokhan et al.; U.S. Pat. No. 5,514,523, issued on May 7, 1996 to Trokhan et al.; U.S. Pat. No. 5,554,467, issued on Sep. 10, 1996, to Trokhan et al.; U.S. Pat. No. 5,566,724, issued on Oct. 22, 1996 to Trokhan et al.; U.S. Pat. No. 5,624,790, issued on Apr. 29, 1997 to Trokhan et al.; U.S. Pat. No. 6,010,598, issued on Jan. 4, 2000 to Boutilier et al.; and, U.S. Pat. No. 5,628,876, issued on May 13, 1997 to Ayers et al., the specification and claims of which are incorporated herein by reference to the extent that they are not contradictory herewith.

In FIG. 1, a twin wire former 8 having a papermaking headbox 10 injects or deposits a stream 11 of an aqueous suspension of papermaking fibers onto a plurality of forming fabrics, such as the outer forming fabric 12 and the inner forming fabric 13, thereby forming a wet tissue web 15. The forming process of the present invention may be any conventional forming process known in the papermaking industry. Such formation processes include, but are not limited to, Fourdriniers, roof formers such as suction breast roll formers, and gap formers such as twin wire formers and crescent formers.

The wet tissue web 15 forms on the inner forming fabric 13 as the inner forming fabric 13 revolves about a forming roll 14. The inner forming fabric 13 serves to support and carry the newly-formed wet tissue web 15 downstream in the process as the wet tissue web 15 is partially dewatered to a consistency of about 10 percent based on the dry weight of the fibers. Additional dewatering of the wet tissue web 15 may be carried out by known paper making techniques, such as vacuum suction boxes, while the inner forming fabric 13 supports the wet tissue web 15. The wet tissue web 15 may be additionally dewatered to a consistency of at least about 20%, more specifically between about 20% to about 40%, and more specifically about 20% to about 30%. The wet tissue web 15 is then transferred from the inner forming fabric 13 to a transfer fabric 17 traveling preferably at a slower speed than the inner forming fabric 13 in order to impart increased MD stretch into the wet tissue web 15. (The term “machine direction” or MD means the length of a web or film in the direction in which it is produced. The term “cross machine direction” or CD means the width of a web or film, i.e. a direction generally perpendicular to the MD.)

The wet tissue web 15 is then transferred from the transfer fabric 17 to a throughdrying fabric 19 whereby the wet tissue web 15 may be macroscopically rearranged to conform to the surface of the throughdrying fabric 19 with the aid of a vacuum transfer roll 20 or a vacuum transfer shoe like the vacuum shoe 18. If desired, the throughdrying fabric 19 can be run at a speed slower than the speed of the transfer fabric 17 to further enhance MD stretch of the resulting absorbent tissue product 27. The transfer may be carried out with vacuum assistance to ensure conformation of the wet tissue web 15 to the topography of the throughdrying fabric 19.

While supported by the throughdrying fabric 19, the wet tissue web 15 is dried to a final consistency of about 94 percent or greater by a throughdryer 21 and is thereafter transferred to a carrier fabric 22. Alternatively, the drying process can be any noncompressive drying method that tends to preserve the bulk of the wet tissue web 15.

The dried tissue web 23 is transported to a reel 24 using a carrier fabric 22 and an optional carrier fabric 25. An optional pressurized turning roll 26 can be used to facilitate transfer of the dried tissue web 23 from the carrier fabric 22 to the carrier fabric 25. If desired, the dried tissue web 23 may additionally be embossed to produce a pattern on the absorbent tissue product 27 produced using the throughdrying fabric 19 and a subsequent embossing stage. It is understood that in some embodiments of the present invention, a carrier fabric 22 is optional.

Once the wet tissue web 15 has been non-compressively dried, thereby forming the dried tissue web 23, it is possible to crepe the dried tissue web 23 by transferring the dried tissue web 23 to a Yankee dryer prior to reeling, or using alternative foreshortening methods such as microcreping as disclosed in U.S. Pat. No. 4,919,877 issued on April, 24, 1990 to Parsons et al.

In an alternative embodiment not shown, the wet tissue web 15 may be transferred directly from the inner forming fabric 13 to the throughdrying fabric 19 and the transfer fabric 17 eliminated. The throughdrying fabric 19 may be traveling at a speed less than the inner forming fabric 13 such that the wet tissue web 15 is rush transferred, or, in the alternative, the throughdrying fabric 19 may be traveling at substantially the same speed as the inner forming fabric 13. If the throughdrying fabric 19 is traveling at a slower speed than the speed of the inner forming fabric 13, an uncreped absorbent tissue product 27 is produced. Additional foreshortening after the drying stage may be employed to improve the MD stretch of the absorbent tissue product 27. Methods of foreshortening the absorbent tissue product 27 include, by way of illustration and without limitation, conventional Yankee dryer creping, microcreping, or any other method known in the art.

Differential velocity transfer from one fabric to another can follow the principles taught in any one of the following patents, each of which is herein incorporated by reference to the extent it is not contradictory herewith: U.S. Pat. No. 5,667,636, issued on Sep. 16, 1997 to Engel et al.; U.S. Pat. No. 5,830,321, issued on Nov. 3, 1998 to Lindsay et al.; U.S. Pat. No. 4,440,597, issued on Apr. 3, 1984 to Wells et al.; U.S. Pat. No. 4,551,199, issued on Nov. 5, 1985 to Weldon; and, U.S. Pat. No. 4,849,054, issued on Jul. 18, 1989 to Klowak.

In yet another alternative embodiment of the present invention, the inner forming fabric 13, the transfer fabric 17, and the throughdrying fabric 19 can all be traveling at substantially the same speed. Foreshortening may be employed to improve MD stretch of the absorbent tissue product 27. Such methods include, by way of illustration without limitation, conventional Yankee dryer creping or microcreping.

Any known papermaking or tissue manufacturing method may be used to create a web 23 using the tissue making fabrics. Though the tissue making fabrics may be useful as transfer and through drying fabrics and may be used with any known tissue making process that employs throughdrying, the tissue making fabrics may also be used in the formation of wet tissue webs 15 as forming fabrics, carrier fabrics, drying fabrics, imprinting fabrics, and the like in any known papermaking or tissue making process. Such methods can include variations comprising any one or more of the following steps in any feasible combination:

wet tissue web formation in a wet end in the form of a classical Fourdrinier, a gap former, a twin-wire former, a crescent former, or any other known former comprising any known headbox, including a stratified headbox for bringing layers of two or more furnishes together into a single tissue web, or a plurality of headboxes for forming a multi-layered tissue web, using known wires and tissue making fabrics;

wet tissue web formation or wet tissue web dewatering by foam-based processes, such as processes wherein the fibers are entrained or suspended in a foam prior to dewatering, or wherein foam is applied to an embryonic wet tissue web prior to dewatering or drying, including the methods disclosed in U.S. Pat. No. 5,178,729, issued on Jan. 12, 1993 to Janda, and U.S. Pat. No. 6,103,060, issued on Aug. 15, 2000 to Munerelle et al., both of which are herein incorporated by reference to the extent they are not contradictory herewith;

differential basis weight formation by draining a slurry through a forming fabric having high and low permeability regions, including known tissue making or forming fabrics;

rush transfer of a wet tissue web from a first fabric to a second fabric moving at a slower velocity than the first fabric, wherein the first fabric can be a forming fabric, a transfer fabric, or a throughdrying fabric, and wherein the second fabric can be a transfer fabric, a throughdrying fabric, a second throughdrying fabric, or a carrier fabric disposed after a throughdrying fabric (one exemplary rush transfer process is disclosed in U.S. Pat. No. 4,440,597, issued on Apr. 3, 1984 to Wells et al., herein incorporated by reference to the extent that it is non-contradictory herewith), wherein the aforementioned fabrics can be selected from any suitable fabrics known in the art;

application of differential air pressure across the wet tissue web to mold it into one or more of the fabrics on which the wet tissue web rests, such as using a high vacuum pressure in a vacuum transfer roll or transfer shoe to mold a wet tissue web into a throughdrying fabric as it is transferred from a forming fabric or intermediate carrier fabric, wherein the carrier fabric, throughdrying fabric, or other fabrics known in the art;

use of an air press or other gaseous dewatering methods to increase the dryness of a tissue web and/or to impart molding to the tissue web, as disclosed in U.S. Pat. No. 6,096,169, issued on Aug. 1, 2000 to Hermans et al.; U.S. Pat. No. 6,197,154, issued on Mar. 6, 2001 to Chen et al.; and, U.S. Pat. No. 6,143,135, issued on Nov. 7, 2000 to Hada et al., all of which are herein incorporated by reference to the extent they are not contradictory herewith;

drying the wet tissue web by any compressive or noncompressive drying process, such as throughdrying, drum drying, infrared drying, microwave drying, wet pressing, impulse drying (e.g., the methods disclosed in U.S. Pat. No. 5,353,521, issued on Oct. 11, 1994 to Orloff and U.S. Pat. No. 5,598,642, issued on Feb. 4, 1997 to Orloff et al.), high intensity nip dewatering, displacement dewatering (see J. D. Lindsay, “Displacement Dewatering To Maintain Bulk,” Paperi Ja Puu, vol. 74, No. 3, 1992, pp. 232-242), capillary dewatering (see any of U.S. Pat. Nos. 5,598,643; 5,701,682; and 5,699,626, all of which issued to Chuang et al.), steam drying, etc.

printing, coating, spraying, or otherwise transferring a chemical agent or compound on one or more sides of the wet tissue web uniformly or heterogeneously, as in a pattern, wherein any known agent or compound useful for a web-based product can be used (e.g., a softness agent such as a quaternary ammonium compound, a silicone agent, an emollient, a skin-wellness agent such as aloe vera extract, an antimicrobial agent such as citric acid, an odor-control agent, a pH control agent, a sizing agent; a polysaccharide derivative, a wet strength agent, a dye, a fragrance, and the like), including the methods of U.S. Pat. No. 5,871,763, issued on Feb. 16, 1999 to Luu et al.; U.S. Pat. No. 5,716,692, issued on Feb. 10, 1998 to Warner et al.; U.S. Pat. No. 5,573,637, issued on Nov. 12, 1996 to Ampulski et al.; U.S. Pat. No. 5,607,980, issued on Mar. 4, 1997 to McAtee et al.; U.S. Pat. No. 5,614,293, issued on Mar. 25, 1997 to Krzysik et al.; U.S. Pat. No. 5,643,588, issued on Jul. 1, 1997 to Roe et al.; U.S. Pat. No. 5,650,218, issued on Jul. 22, 1997 to Krzysik et al.; U.S. Pat. No. 5,990,377, issued on Nov. 23, 1999 to Chen et al.; and, U.S. Pat. No. 5,227,242, issued on Jul. 13, 1993 to Walter et al., each of which is herein incorporated by reference to the extent they are not contradictory herewith; imprinting the wet tissue web on a Yankee dryer or other solid surface, wherein the wet tissue web resides on a fabric that can have deflection conduits (openings) and elevated regions (including the fabrics of the present invention), and the fabric is pressed against a surface such as the surface of a Yankee dryer to transfer the wet tissue web from the fabric to the surface of the Yankee dryer, thereby imparting densification to portions of the wet tissue web that were in contact with the elevated regions of the fabric, whereafter the selectively densified dried tissue web can be creped from or otherwise removed from the surface of the Yankee dryer;

creping the dried tissue web from a drum dryer, optionally after application of a strength agent such as latex to one or more sides of the tissue web, as exemplified by the methods disclosed in U.S. Pat. No. 3,879,257, issued on Apr. 22, 1975 to Gentile et al.; U.S. Pat. No. 5,885,418, issued on Mar. 23, 1999 to Anderson et al.; U.S. Pat. No. 6,149,768, issued on Nov. 21, 2000 to Hepford, all of which are herein incorporated by reference to the extent they are not contradictory herewith;

creping with serrated crepe blades (e.g., see U.S. Pat. No. 5,885,416, issued on Mar. 23, 1999 to Marinack et al.) or any other known creping or foreshortening method; and,

converting the tissue web with known operations such as calendering, embossing, slitting, printing, forming a multiply structure having two, three, four, or more plies, putting on a roll or in a box or adapting for other dispensing means, packaging in any known form, and the like.

Various fibers may be employed in forming tissue webs used in the manufacture of the consumer products, including facial tissues, paper towels, napkins, wipes, and bath tissue. For example, wood pulp fibers, in 100% amounts, may be utilized. Alternatively, mixtures of wood pulp fibers with other types of fibers, including various synthetic fibers such as meltblown and spunbonded fibers may be used. In addition, other types of fibers and filaments may be used to provide desired characteristics to the tissue webs. For example, bleached fibers produced from high yield pulping processes, including but not limited to thermal mechanical pulping processes, thermal chemi-mechanical pulping processes, bleached thermal chemi-mechanical pulping processes (providing fibers such as bleached chemi-thermomechanical pulp (BCTMP)), or ground wood and chemi-ground wood processes, as well as curled fibers that are produced by various methods such as by high-consistency refining, and fibers that are internally cross-linked may be employed.

Different characteristics may be introduced into the tissue webs by differences in fiber species (for example, percentage of hardwood versus softwood): fiber length; fiber yield; fiber treatment with processes which change fiber morphology or chemistry such as mechanical refining, fiber fractionation, dispersing to impart curl, steam explosion, enzymatic treatment, chemical crosslinking, ozonation, bleaching, lumen loading with fillers, or other chemical agents, supercritical fluid treatment, including supercritical fluid extraction of agents in the fiber or supercritical fluid deposition of solutes on and into the cell wall, and the like. The chemicals that may be added to or on the tissue web may include debonding agents, anti-bacterial agents, wet strength resins, starches, proteins, superabsorbent particles, fiber plasticizers such as glycols, colorants, opacifiers, surfactants, zinc oxide, baking soda, silicone compounds, zeolites, activated carbon, and the like.

The cellulose-based consumer products may be sensitive to light exposure. The appearance of the tissue webs and/or the consumer products manufactured from the tissue webs may change in the presence of light, especially UV light. One such appearance change that the tissue webs and/or cellulose-based consumer products typically undergo in the presence of light is a yellowing or browning discoloration. One such example is the exposure of such consumer products to light during production, shipping, storage, or display on store shelves. Cellulose-based consumer products comprising BCTMP, especially softwood BCTMP, may be even more sensitive to light exposure. The longer the period of exposure to light, the more discoloration is typically introduced into the tissue web and/or cellulose-based consumer product.

Such discoloration is sometimes referred to as ‘light aging effect’ or ‘yellowing’. While such discoloration is a natural process, it is not a desired process in consumer products. While not wishing to be bound by any theory, it is believed that UV light, also known as ‘black light’, interacts with the lignin in the tissue webs and/or cellulose-based consumer products, causing discoloration; The length of time of the light exposure as well as the intensity of the light exposure may affect the degree of discoloration that may occur. The discoloration may be further affected by the presence of air and humidity as well as the temperature the tissue web and/or consumer products are exposed to.

One way to avoid or reduce this discoloration is to use thermoplastic packaging film having UV-absorbing or deflecting characteristics to wrap the tissue web and/or consumer products made from the tissue webs. In one embodiment of the present invention, the tissue web may be wrapped in an UV-protective thermoplastic packaging film. In another embodiment, an UV-protective thermoplastic packaging film may be used to wrap individual units of the consumer products and/or multi-units of consumer products. The UV-protective thermoplastic packaging film may be used as the material for bags or pouches into which single or multi-units of the consumer products may be packaged. In another embodiment of the present invention, the UV-protective thermoplastic packaging film may also be used to wrap multiple packages of consumer products. Such an UV-protective thermoplastic packaging film may also be used to hold stacked packaged consumer products, such as on a pallet in another embodiment. In another embodiment, other packaging using the UV-protective thermoplastic packaging film, only a portion, such as a window element, may comprise the UV-protective thermoplastic packaging film. One advantage of such packaging that incorporates the UV-protective thermoplastic packaging film is that the consumer may view the consumer products contained within.

The UV-protective thermoplastic packaging film may have UV-absorbing or deflecting characteristics. The UV-protective thermoplastic packaging film may comprise inorganic compounds such as metal oxides. Examples of the metal oxides include titanium dioxide (TiO₂) and zinc oxide (ZnO). Other UV-protective thermoplastic packaging films may be treated with yellow pigments to provide protection against the violet portion of visible light. The yellow pigments may be contained within the UV-protective thermoplastic packaging films or applied to at least one surface of the UV-protective thermoplastic packaging films. Other UV-protective thermoplastic packaging films may comprise organic compounds, typically polar, having UV-absorbing characteristics. Examples of such organic compounds include benzotriazoles, such as hydroxyphenylbenzotriazole, and benzophenones, such as hydroxybenzophenone.

The UV-protective thermoplastic packaging film may deflect, absorb, or deflect and absorb UV light having wavelengths between about 200 and about 435 nm, more specifically about 280 and about 390 nm, and more specifically between about 300 and about 370 nm. The UV-protective thermoplastic packaging film absorbs and/or deflects about 90% or more of the light having UV wavelengths, more specifically about 93% or more of the light having UV wavelengths, more specifically about 95% or more of the light having UV wavelengths, more specifically about 96% or more of the light having UV wavelengths, more specifically about 97% or more of the light having UV wavelengths, and most specifically about 98% or more of the light having UV wavelengths.

The thickness of the UV-protective thermoplastic packaging film may vary the effectiveness of the UV-absorbing or deflecting characteristics of the UV-protective thermoplastic packaging film. Typically, the thicker (the higher gauge) the UV-protective thermoplastic packaging film of a given composition, the more effective the UV-absorbing and/or deflecting characteristic of the UV-protective thermoplastic packaging film is. The UV-protective thermoplastic packaging film may have a thickness of about 125 μm or less, more typically about 100 μm or less, more typically about 80 μm or less, more typically about 50 μm or less, more typically about 35 μm or less.

The UV-protective thermoplastic packaging film may comprise a single layer or may comprise two or more layers. In addition, the UV-protective thermoplastic packaging film may comprise one or more plies. The base resin which may be suitable for the UV-protective thermoplastic packaging film include polyethylene, polypropylene, polyester, polyvinyl chloride, polyolefin, and combinations thereof.

The UV-protective thermoplastic packaging film may comprise a stretchable film. A stretchable UV-protective thermoplastic packaging film may exhibit stretch characteristics ranging from about 50% to about 850% of its original length (unstretched, relaxed, length). More typically, a stretchable UV-protective thermoplastic packaging film may exhibit stretch characteristics ranging from about 100% to about 800%, more typically from about 150% to about 700%, more typically from about 200% to about 600%, more typically from about 250% to about 500%, more typically from about 250% to about 450%, more typically from about 300% to about 450%, and most typically from about 300% to about 400%. In other embodiments, the stretchable UV-protective thermoplastic packaging film may exhibit stretch characteristics ranging from about 100% to about 800%, more typically from about 150% to about 700%, more typically from about 200% to about 700%, more typically from about 250% to about 700%, more typically from about 250% to about 650%, more typically from about 300% to about 650%, and most typically from about 300% to about 550%. The elongation of a stretchable film may be determined by ASTM D882

The UV-protective thermoplastic packaging film may comprise a shrinkable film. A shrinkable UV-protective thermoplastic packaging film may exhibit shrinkage characteristics ranging from about 10% to about 85% of its original length (unshrunk, relaxed, length). More typically, a shrinkable UV-protective thermoplastic packaging film may exhibit shrinkage characteristics ranging from about 10% to about 80%, more typically from about 15% to about 75%, more typically from about 20% to about 75%, more typically from about 25% to about 70%, more typically from about 25% to about 65%, more typically from about 30% to about 60%, and most typically from about 40% to about 50%. The UV-protective thermoplastic packaging film could be a polyolefin based, PVC based, or similar mono-layer or multi-layered film.

In accordance with the present invention, the consumer products wrapped in the UV-protective thermoplastic packaging film exhibit little or no light aging effect, discoloration. The consumer products wrapped in the UV-protective thermoplastic packaging film exhibit a change in brightness of about 5 percent or less, more specifically about 4 percent or less, more specifically about 3 percent or less, more specifically about 2 percent or less, more specifically about 1 percent or less, more specifically about 0.75 percent or less, and most specifically about 0.5 percent or less during shipping, storage, or display of the wrapped consumer product. The consumer products wrapped in the UV-protective thermoplastic packaging film exhibit a change in the b-value of about 20 percent or less, more specifically about 15 percent or less, more specifically about 13 percent or less, more specifically about 12 percent or less, more specifically about 11 percent or less, more specifically about 10 percent or less, more specifically about 9 percent or less, and most specifically about 8 percent or less during shipping, storage, or display of the wrapped consumer product. The consumer products wrapped in the UV-protective thermoplastic packaging film will maintain their brightness value and b-value for about 12 months or more, more specifically about 9 months or more, more specifically about 6 months or more, and most specifically about 3 months or more.

### EXAMPLES

Yellowing, the light aging effect, may be measured by spectrophotometric techniques. It is typically expressed in terms of brightness or whiteness and the b-value. The b-value measures the degree of yellowness/blueness of a sample. A positive b-value indicates yellowness of the sample and a negative b-value indicates blueness of the sample. The instrument used was the Technibrite Micro TB-1C, commercially available from the Technidyne Corporation, located in New Albany, Ind. The Technibrite Micro TB-1C measures the integrated intensity (brightness) and spectral distribution (a-value and b-value) of the reflected light from the surface of the tissue web or consumer product. As the discoloration of the tissue web and/or consumer product progresses, the brightness of the tissue web and/or consumer product typically continues to decrease. In addition, as the discoloration of the tissue web and/or consumer product progresses, the b-value typically continues to increase. Typically changes of more than about 0.5 units of the brightness value or the b-value are detectable to the human eye, especially when two samples of tissue webs and/or consumer product are compared.

Single-ply towel products were used to determine the effectiveness of a UV-protective thermoplastic packaging film. One of the single-ply towel products was a three-layered towel product. The other single-ply towel product was a blended (non-layered) towel product. The single-ply three-layered towel product had a finished (oven dried basis) basis weight of about 22.7 pounds per 2880 square feet. The single-ply three-layered towel product was made generally in accordance with the following procedure using northern softwood kraft pulp fibers (LL-19), fully bleached, in the outer layers and northern softwood kraft pulp fibers (LL-19), BCTMP, and broke in the inner layer. The overall layered towel product weight was split about 74% northern softwood kraft pulp fibers and 26% BCTMP. The towel product contained 21% broke made up of the same composition of northern softwood kraft pulp fibers and BCTMP. About 13,920 pounds (oven dry basis) of northern softwood kraft pulp fibers were dispersed in a pulper for about 20 minutes at a consistency of about 4.5%. About 12,180 pounds (oven dry basis) of BCTMP pulp fibers, commercially available from Pulp Miller Western located at Whitecourt, Alberta, Canada and about 4,000 pounds (oven dry basis) of broke were dispersed in a pulper for about 20 minutes at a consistency of about 10%. The kraft pulp fiber slurries were then transferred to two machine chests and diluted to a consistency of about 3.5 to about 10%. Kymene 6500, a commercially available PAE wet strength resin from Hercules Inc. located in Chicopee, Me., was added to both kraft pulp fiber slurries in the machine chests at a rate of about 8 to about 10 kilogram dry chemical per ton of dry fiber. CMC, Avalon 7MCT, commercially available from Hercules Inc. located at Hattiesburg, Miss., was added to both kraft pulp fiber slurries in the machine chests at a rate of about 1 to about 2.5 kilogram dry chemical per ton of dry fiber.

The kraft pulp fiber slurries were further diluted to about 0.1% consistency prior to forming and deposited from a three layered headbox onto a fine forming fabric having a velocity of about 5,000 feet per minute to form an about 212 inch wide towel web. The flow rates of the kraft pulp fiber slurries into the flow spreader were adjusted to give a target sheet basis weight of about 40 gsm. The kraft pulp fiber slurries were drained on the forming fabric, building a layered embryonic towel web. The embryonic towel web was dewatered to a consistency of at about 10 percent or greater. The embryonic towel web was transferred to a transfer fabric. The embryonic towel web was then transferred to a throughdrying fabric. The embryonic towel web was dried to a final consistency of about 94 percent or greater by a throughdryer thereby forming a finished layered towel web. The finished layered towel web was then converted into a single-ply three-layered towel product.

The single-ply blended towel product had a finished (oven dried basis) basis weight of about 22.7 pounds per 2880 square feet. The single-ply blended towel product was made generally in accordance with the following procedure using northern softwood kraft pulp fibers (LL-19), fully bleached, northern hardwood kraft pulp fibers (LL-16), BCTMP, and broke. The overall blended towel product weight was split about 50% northern softwood kraft pulp fibers, about 25% BCTMP, and about 25% northern hardwood kraft pulp fibers. The towel product contained about 18% broke made up of the same composition of northern softwood kraft pulp fiber, BCTMP, and northern hardwood kraft pulp fibers. The towel product and about 18% broke kraft pulp fibers. About 5589 pounds (oven dry basis) of northern softwood kraft pulp fibers were dispersed in a pulper for about 10 minutes at a consistency of about 6%. About 2795 pounds (oven dry basis) of BCTMP, commercially available from Pulp Miller Western located at Whitecourt, Alberta, Canada, and about 2795 pounds (oven dry basis) of northern hardwood kraft pulp fibers were dispersed in a pulper for about 10 minutes at a consistency of about 6%. About 2500 pounds (oven dry basis) of broke was dispersed in a pulper for about 40 to about 60 minutes at a consistency of about 4%. The kraft pulp fiber slurry was then transferred to a machine chest and diluted to a consistency of about 3.5 to about 4%. Kymene 6500, a commercially available PAE wet strength resin from Hercules Inc. located in Chicopee, Me., was added to the kraft pulp fiber slurry in the machine chest at a rate of about 6 to about 15 kilogram dry chemical per ton of dry fiber. CMC 7MCT, commercially available from Hercules Inc. located at Hattiesburg, Miss., was added to the kraft pulp fiber slurry in the machine chest at a rate of about 1 to about 2 kilogram dry chemical per ton of dry fiber.

The kraft pulp fiber slurry was further diluted to about 0.2% consistency prior to forming and deposited from an unlayered headbox onto a fine forming fabric having a velocity of about 1,900 feet per minute to form an about 202 inch wide towel web. The flow rate of the kraft pulp fiber slurry into the headbox was adjusted to give a target sheet basis weight of about 40 gsm. The kraft pulp fiber slurry was drained on the forming fabric, building a blended embryonic towel web. The embryonic towel web was dewatered to a consistency of at about 10 percent or greater. The embryonic towel web was transferred to a transfer fabric. The embryonic towel web was then transferred to a throughdrying fabric. The embryonic towel web was dried to a final consistency of about 94 percent or greater by a throughdryer thereby forming a finished blended towel web. The finished layered towel web was then converted into a single-ply blended towel product.

The single-ply three-layered towel and single-ply blended towel products tested were single rolls wrapped in the UV-protective thermoplastic packaging film compared to single rolls that are not wrapped in a thermoplastic packaging film. The UV-protective chemical that is embedded in the UV-protective thermoplastic packaging film is not in direct contact with the pulp fiber in the consumer product. Therefore, the UV-protective chemical is not transferred to towel product or to any surface that comes into contact with the towel product.

The single-ply three-layered towel product was unwound and the first six (6) sheets were discarded. Then ten (10) single sheets were torn off the roll of towel product. The ten (10) single sheets of the towel product are then stacked one on top of the other, forming a pad of ten (10) single sheets of towel product. Each pad was cut into quarter towel sheet size, thereby forming samples of quarter towel sheet size pads. Each sample of quarter towel sheet size pad was placed in the center of a light impermeable folder, in which on one side of the folder a window has been cut into the center of that side. The dimension of the window is about 3⅝ inches by about 3⅝ inches. The windows on one half of the light impermeable folders were left open (no film placed over the windows). In the other half of the light impermeable folder, the windows were covered with the UV protective thermoplastic packaging film having a 48 gauge or a 92 gauge. The UV-protective thermoplastic packaging film is Courtgard™, a clear polyester film commercially available from CPFilm, Inc., located at Martinsville, Va. The edges of the folder were sealed with masking tape to prevent light exposure of the sample of quarter towel sheet size pads other than light through the window of the light impermeable folder containing the sample of quarter towel sheet size pad.

Each light impermeable folder sample was labeled with the number of hours of the predetermined exposure period to UV light having wavelengths between about 300 and about 400 nm. The light source of the UV light cabinet is operated 20 minutes before the samples were placed within the UV light cabinet, thereby allowing the temperature within the UV light cabinet to equilibrate. The samples of quarter towel sheet size pads were placed into a UV light cabinet, equipped with a light source comprising eight (8) Sylvania F40/350 BL bulbs (40 watts each). The UV light cabinet simulates accelerated exposure to filtered sunlight through window glass and fluorescent lighting. Eight (8) samples of quarter towel sheet size pads were laid onto each of the shelves, such that the window of each light impermeable folder is fully exposed to the light source.

The UV light cabinet was constructed out of wood materials (although any material may be used that is capable of preventing transmission of light into or out of the UV light cabinet) and has the dimensions of: about 48 inches in height, about 53 inches in length, and about 19 inches in width. The UV light cabinet contains two shelves made of wood materials (although any material may be used that is capable of preventing transmission of light through the shelf). The samples of quarter towel sheet size pads on each shelf are exposed to light from four (4) of the Sylvania F40/350 BL bulbs. The samples of quarter towel sheet size pads were placed at least about 14 inches from the side walls of the UV light cabinet and at least about 4 inches from the front and back walls of the UV light cabinet. The temperature inside of the UV light cabinet is maintained between about 46 to about 47° C. The temperature inside of the UV light cabinet was measured by a thermocouple.

The samples of quarter towel sheet size pads were placed about 14 inches from the light source. Sixteen (16) samples of quarter towel sheet size pads were placed in the UV light cabinet at a time (eight samples on each shelf). Each sample of quarter towel sheet size pads was removed from the UV light cabinet when the predetermined exposure period had been reached. The light intensity inside of the UV light cabinet was measured by the Simpson Model 408-2 Illumination Level Meter, available from Simpson Electric Company, located in Elgin, Ill. The meter consists of a sensor and an indicator having a range selector switch. The meter measures the intensity of a light source, indicating the foot-candles (fc) of light absorbed by the sensor of the meter. The intensity of the light source of each shelf in the UV light cabinet was measured as 80 fc. This measurement reflects the sum of the light from the light source and the reflected light. The samples of quarter towel sheet size pads were exposed to the UV light in the UV light cabinet for up to a total of 6 hours.

Brightness and b-values were measured of each sample using the Technibrite Micro TB-1C instrument shortly after its removal from the UV light cabinet. The Technibrite Micro TB-1C instrument is capable of measuring a variety of tissue attributes, such as L-values, b-values, a-values, and brightness values. The samples of quarter towel sheet size pads were removed from the light impermeable folders. The sample of quarter towel sheet size pads were placed one at a time into the Technibrite Micro TB-1C instrument wherein the brightness value and the b-value were measured.

The predetermined exposure times for the samples of quarter towel sheet size pads varied from 0 hour, 1 hour, 2 hours, 3 hours, 4 hours, 5 hours, and 6 hours. Each hour of exposure in the UV light cabinet corresponds to approximately one month of exposure in an office environment. The UV protective thermoplastic packaging film used stayed clear during the exposure in the UV light cabinet, showing no discoloration.

The process for sample preparation and handling was repeated for the single-ply blended towel product.

The comparison data for the single-ply three-layered towel product and the single-ply blended towel product wrapped in the UV-protective thermoplastic packaging film having a gauge of 48 and unwrapped is provided in Table 1.

TABLE 1

| | | | | |
|---|---|---|---|---|
| Time | Brightness | | b-value | |
| (hrs) | No Film | Film | No Film | Film |

Layered Towel Products

| | | | | |
|---|---|---|---|---|
| 0 | 81.8 | 81.8 | 3.50 | 3.50 |
| 1 | 74.5 | 81.3 | 6.59 | 3.49 |
| 2 | 72.9 | 81.2 | 7.49 | 3.65 |
| 3 | 71.4 | 80.9 | 8.13 | 3.70 |
| 4 | 69.8 | 80.7 | 9.01 | 3.78 |
| 5 | 68.7 | 80.7 | 9.41 | 3.84 |
| 6 | 67.7 | 80.5 | 9.75 | 3.87 |

Blended Towel Products

| | | | | |
|---|---|---|---|---|
| 0 | 80.5 | 80.5 | 4.57 | 4.57 |
| 1 | 73.5 | 80.2 | 7.22 | 4.61 |
| 2 | 72.1 | 79.7 | 7.99 | 4.71 |
| 3 | 71.0 | 79.6 | 8.63 | 4.74 |
| 4 | 69.8 | 79.3 | 9.12 | 4.79 |
| 5 | 68.8 | 79.0 | 9.56 | 4.93 |
| 6 | 67.8 | 78.9 | 10.00 | 4.93 |

The comparison data for single-ply three-layered towel product and the single-ply blended towel product wrapped in the Courtgard™ UV-protective thermoplastic packaging film having a gauge of 92. The comparison data for the towel products wrapped in the UV-protective thermoplastic packaging film and unwrapped is provided in Table 2.

TABLE 2

| | | | | |
|---|---|---|---|---|
| Time | Brightness | | b-value | |
| (hrs) | No Film | Film | No Film | Film |

Layered Towel Products

| | | | | |
|---|---|---|---|---|
| 0 | 81.8 | 81.8 | 3.50 | 3.50 |
| 1 | 74.5 | 81.4 | 6.59 | 3.49 |
| 2 | 72.9 | 80.9 | 7.49 | 3.68 |
| 3 | 71.4 | 80.7 | 8.13 | 3.77 |
| 4 | 69.8 | 80.8 | 9.01 | 3.82 |
| 5 | 68.7 | 80.7 | 9.41 | 3.88 |
| 6 | 67.7 | 80.4 | 9.75 | 3.94 |

Blended Towel Products

| | | | | |
|---|---|---|---|---|
| 0 | 80.5 | 80.5 | 4.57 | 4.57 |
| 1 | 73.5 | 80.0 | 7.22 | 4.61 |
| 2 | 72.1 | 79.7 | 7.99 | 4.69 |
| 3 | 71.0 | 79.6 | 8.63 | 4.78 |
| 4 | 69.8 | 79.2 | 9.12 | 4.83 |
| 5 | 68.8 | 79.1 | 9.56 | 4.89 |
| 6 | 67.8 | 78.9 | 10.00 | 4.93 |

The comparison data for single-ply three-layered towel product and the single-ply blended towel product wrapped in the Teijin Film™ Melinex® film type 389 UV-protective thermoplastic packaging film having a gauge of 80. The Melinex® film is a coextruded UV-stable film available from DuPont Teijin Films located at Hopewell, Va. The process for sample preparation and handling was carried out as discussed above. The comparison data for the towel products wrapped in the UV-protective thermoplastic packaging film is provided in Table 3.

TABLE 3

| | | |
|---|---|---|
| Time | Brightness | b-value |
| (hrs) | Film | Film |

Layered Towel Products

| | | |
|---|---|---|
| 0 | 81.9 | 3.50 |
| 2 | 80.3 | 3.96 |
| 4 | 79.8 | 4.27 |
| 6 | 79.0 | 4.57 |
| 8 | 79.0 | 4.62 |

Blended Towel Products

| | | |
|---|---|---|
| 0 | 80.4 | 4.64 |
| 2 | 79.0 | 4.88 |
| 4 | 78.5 | 5.23 |
| 6 | 77.6 | 5.47 |
| 8 | 77.3 | 5.63 |

The comparison data for single-ply three-layered towel product and the single-ply blended towel product wrapped in the Teijin Film™ Melinex® film type 389 UV-protective thermoplastic packaging film having a gauge of 120. The Melinex® film is a coextruded UV stable film available from DuPont Teijin Films located at Hopewell, Va. The process for sample preparation and handling was carried out as discussed above. The comparison data for the towel products wrapped in the UV-protective thermoplastic packaging film is provided in Table 4.

TABLE 4

| | | |
|---|---|---|
| Time | Brightness | b-value |
| (hrs) | Film | Film |

Layered Towel Products

| | | |
|---|---|---|
| 0 | 81.9 | 3.50 |
| 2 | 81.0 | 3.64 |
| 4 | 80.5 | 3.88 |
| 6 | 79.8 | 4.07 |
| 8 | 80.0 | 4.10 |

Blended Towel Products

| | | |
|---|---|---|
| 0 | 80.4 | 4.64 |
| 2 | 79.4 | 4.67 |
| 4 | 79.4 | 4.81 |
| 6 | 78.8 | 4.91 |
| 8 | 78.6 | 4.93 |

The comparison data for single-ply three-layered towel product and the single-ply blended towel product wrapped in Sablock™ pouching film UV-protective thermoplastic packaging film. The Sablock™ pouching film is a laminated polyester/polyethylene film available from Oliver® Products Company located at Grand Rapids, Mich. The process for sample preparation and handling was carried out as discussed above. The comparison data for the towel products wrapped in the UV-protective thermoplastic packaging film is provided in Table 5.

TABLE 5

| | | |
|---|---|---|
| Time | Brightness | b-value |
| (hrs) | Film | Film |

Layered Towel Products

| | | |
|---|---|---|
| 0 | 81.9 | 3.50 |
| 2 | 81.0 | 3.66 |
| 4 | 80.7 | 3.98 |
| 6 | 79.9 | 4.20 |
| 8 | 79.9 | 4.25 |

Blended Towel Products

| | | |
|---|---|---|
| 0 | 80.4 | 4.64 |
| 2 | 79.7 | 4.61 |
| 4 | 79.5 | 4.81 |
| 6 | 78.9 | 4.98 |
| 8 | 78.6 | 5.06 |

The comparison data for single-ply three-layered towel product and the single-ply blended towel product wrapped in Bemis TiO₂ UV-protective thermoplastic packaging film containing 2.5% TiO₂ having a thickness of about 1 milli-inch. The Bemis TiO₂ UV protective thermoplastic film is available from Bemis located at Terra Haute, Ind. under the trade designation C22-9225. The process for sample preparation and handling was carried out as discussed above except that light impermeable folders having windows with no film covering the window opening are replaced with light impermeable folders with the window opening covered with C07-9225 film. The C07-9225 film is a medium density polyethylene extruded film available from Bemis located at Terra Haute, Ind. The samples wherein the window of the light impermeable folder is covered with the C07-9225 film are referred to as the control. The comparison data for the towel products wrapped in the C22-9225 UV-protective thermoplastic packaging film and wrapped in the C07-9225 film is provided in Table 6.

TABLE 6

| | | |
|---|---|---|
| Time | b-value | b-value |
| (hrs) | Control | Film |

Layered Towel Products

| | | |
|---|---|---|
| 0 | 3.54 | 3.54 |
| 1 | 6.41 | 5.83 |
| 2 | 7.51 | 7.03 |
| 3 | 8.31 | 7.72 |
| 4 | 8.94 | 8.20 |
| 5 | 9.49 | 8.69 |
| 6 | 9.87 | 9.10 |
| 7 | 10.35 | 9.41 |
| 8 | 10.67 | 9.93 |
| 9 | 11.04 | 10.13 |

Blended Towel Products

| | | |
|---|---|---|
| 0 | 4.72 | 4.72 |
| 1 | 7.07 | 6.61 |
| 2 | 7.98 | 7.27 |
| 3 | 8.63 | 7.84 |
| 4 | 9.35 | 8.37 |
| 5 | 9.81 | 8.78 |
| 6 | 10.22 | 9.10 |
| 7 | 10.61 | 9.41 |
| 8 | 10.94 | 9.82 |
| 9 | 11.45 | 10.25 |

The comparison data for single-ply three-layered towel product and the single-ply blended towel product wrapped in Bemis TiO₂ UV-protective thermoplastic packaging film containing 5% TiO₂ having a thickness of about 1 milli-inch. The Bemis TiO₂ UV thermoplastic film is available from Bemis located at Terra Haute, Ind. under the trade designation C22-9571. The process for sample preparation and handling was carried out as discussed above except that light impermeable folders having windows with no film covering the window opening are replaced with light impermeable folders with the window opening covered with C07-9225 film. The C07-9225 film is a medium density polyethylene extruded film available from Bemis located at Terra Haute, Ind. The samples wherein the window of the light impermeable folder is covered with the C07-9225 film are referred to as the control. The comparison data for the towel products wrapped in the C22-9571 UV-protective thermoplastic packaging film and wrapped in the C07-9225 film is provided in Table 7.

TABLE 7

| | | |
|---|---|---|
| Time | b-value | b-value |
| (hrs) | Control | Film |

Layered Towel Products

| | | |
|---|---|---|
| 0 | 3.54 | 3.54 |
| 1 | 6.41 | 5.60 |
| 2 | 7.51 | 6.38 |
| 3 | 8.31 | 7.01 |
| 4 | 8.94 | 7.50 |
| 5 | 9.49 | 7.82 |
| 6 | 9.87 | 8.22 |
| 7 | 10.35 | 8.54 |
| 8 | 10.67 | 8.84 |
| 9 | 11.04 | 9.26 |

Blended Towel Products

| | | |
|---|---|---|
| 0 | 4.72 | 4.72 |
| 1 | 7.07 | 6.29 |
| 2 | 7.98 | 7.02 |
| 3 | 8.63 | 7.58 |
| 4 | 9.35 | 7.99 |
| 5 | 9.81 | 8.43 |
| 6 | 10.22 | 8.76 |
| 7 | 10.61 | 9.12 |
| 8 | 10.94 | 9.40 |
| 9 | 11.45 | 9.90 |

The comparison data for single-ply three-layered towel product and the single-ply blended towel product wrapped in Bemis TiO₂ UV-protective thermoplastic packaging film containing 10% TiO₂ having a thickness of about 1 milli-inch. The Bemis TiO₂ UV thermoplastic film is available from Bemis located at Terra Haute, Ind. under the trade designation C22-9572. The process for sample preparation and handling was carried out as discussed above except that light impermeable folders having windows with no film covering the window opening are replaced with light impermeable folders with the window opening covered with C07-9225 film. The C07-9225 film is a medium density polyethylene extruded film available from Bemis located at Terra Haute, Ind. The samples wherein the window of the light impermeable folder is covered with the C07-9225 film are referred to as the control. The comparison data for the towel products wrapped in the C22-9572 UV-protective thermoplastic packaging film and wrapped in the C07-9225 film is provided in Table 8.

TABLE 8

| | | |
|---|---|---|
| Time | b-value | b-value |
| (hrs) | Control | Film |

Layered Towel Products

| | | |
|---|---|---|
| 0 | 3.54 | 3.54 |
| 1 | 6.41 | 4.82 |
| 2 | 7.51 | 5.39 |
| 3 | 8.31 | 5.66 |
| 4 | 8.94 | 6.13 |
| 5 | 9.49 | 6.36 |
| 6 | 9.87 | 6.66 |
| 7 | 10.35 | 6.95 |
| 8 | 10.67 | 7.10 |
| 9 | 11.04 | 7.35 |
| 0 | 4.72 | 4.72 |

Blended Towel Products

| | | |
|---|---|---|
| 1 | 7.07 | 6.23 |
| 2 | 7.98 | 6.96 |
| 3 | 8.63 | 7.37 |
| 4 | 9.35 | 7.77 |
| 5 | 9.81 | 7.83 |
| 6 | 10.22 | 8.21 |
| 7 | 10.61 | 8.56 |
| 8 | 10.94 | 9.02 |
| 9 | 11.45 | 9.08 |

The comparison data for single-ply three-layered towel product and the single-ply blended towel product wrapped in Bemis TiO₂ UV-protective thermoplastic packaging film containing 15% TiO₂ having a thickness of about 1 milli-inch. The Bemis TiO₂ UV thermoplastic film is available from Bemis located at Terra Haute, Ind. under the trade designation C22-9573. The process for sample preparation and handling was carried out as discussed above except that light impermeable folders having windows with no film covering the window opening are replaced with light impermeable folders with the window opening covered with C07-9225 film. The C07-9225 film is a medium density polyethylene extruded film available from Bemis located at Terra Haute, Ind. The samples wherein the window of the light impermeable folder is covered with the C07-9225 film are referred to as the control. The comparison data for the towel products wrapped in the C22-9573 UV-protective thermoplastic packaging film and wrapped in the C07-9225 film is provided in Table 9.

TABLE 9

| | | |
|---|---|---|
| Time | b-value | b-value |
| (hrs) | Control | Film |

Layered Towel Products

| | | |
|---|---|---|
| 0 | 3.54 | 3.54 |
| 1 | 6.41 | 4.19 |
| 2 | 7.51 | 4.56 |
| 3 | 8.31 | 4.82 |
| 4 | 8.94 | 5.11 |
| 5 | 9.49 | 5.23 |
| 6 | 9.87 | 5.38 |
| 7 | 10.35 | 5.59 |
| 8 | 10.67 | 5.77 |
| 9 | 11.04 | 5.94 |

Blended Towel Products

| | | |
|---|---|---|
| 0 | 4.72 | 4.72 |
| 1 | 7.07 | 5.18 |
| 2 | 7.98 | 5.43 |
| 3 | 8.63 | 5.68 |
| 4 | 9.35 | 5.97 |
| 5 | 9.81 | 6.05 |
| 6 | 10.22 | 6.20 |
| 7 | 10.61 | 6.37 |
| 8 | 10.94 | 6.43 |
| 9 | 11.45 | 6.80 |

The comparison data for single-ply three-layered towel product and the single-ply blended towel product wrapped in Bemis TiO₂ UV-protective thermoplastic packaging film containing 5% TiO₂ having a thickness of about 0.75 milli-inch. The Bemis TiO₂ UV thermoplastic film is available from Bemis located at Terra Haute, Ind. under the trade designation C22-9571. The process for sample preparation and handling was carried out as discussed above except that light impermeable folders having windows with no film covering the window opening are replaced with light impermeable folders with the window opening covered with C07-9225 film. The C07-9225 film is a medium density polyethylene extruded film available from Bemis located at Terra Haute, Ind. The samples wherein the window of the light impermeable folder is covered with the C07-9225 film are referred to as the control. The comparison data for the towel products wrapped in the C22-9571 UV-protective thermoplastic packaging film and wrapped in the C07-9225 film is provided in Table 10.

TABLE 10
Layered Towel Products

| Time | b-value | b-value |
|---|---|---|
| (hrs) | Control | Film |
| 0 | 3.54 | 3.54 |
| 1 | 6.41 | 5.61 |
| 2 | 7.51 | 6.44 |
| 3 | 8.31 | 7.10 |
| 4 | 8.94 | 7.23 |
| 5 | 9.49 | 8.04 |
| 6 | 9.87 | 8.17 |
| 7 | 10.35 | 8.34 |
| 8 | 10.67 | 8.80 |

The comparison data for single-ply three-layered towel product and the single-ply blended towel product wrapped in Bemis TiO₂ UV-protective thermoplastic packaging film containing 10% TiO₂ having a thickness of about 0.75 milli-inch. The Bemis TiO₂ UV-protective thermoplastic film is available from Bemis located at Terra Haute, Ind. under the trade designation C22-9572. The process for sample preparation and handling was carried out as discussed above except that light impermeable folders having windows with no film covering the window opening are replaced with light impermeable folders with the window opening covered with C07-9225 film. The C07-9225 film is a medium density polyethylene extruded film available from Bemis located at Terra Haute, Ind. The samples wherein the window of the light impermeable folder is covered with the C07-9225 film are referred to as the control. The comparison data for the towel products wrapped in the C22-9572 UV-protective thermoplastic packaging film and wrapped in the C07-9225 film is provided in Table 11.

TABLE 11
Layered Towel Products

| Time | b-value | b-value |
|---|---|---|
| (hrs) | Control | Film |
| 0 | 3.54 | 3.54 |
| 1 | 6.41 | 4.82 |
| 2 | 7.51 | 5.39 |
| 3 | 8.31 | 5.66 |
| 4 | 8.94 | 6.13 |
| 5 | 9.49 | 6.36 |
| 6 | 9.87 | 6.66 |
| 7 | 10.35 | 6.95 |
| 8 | 10.67 | 7.10 |
| 9 | 11.04 | 7.35 |

The comparison data for single-ply three-layered towel product and the single-ply blended towel product wrapped in Bemis TiO₂ UV-protective thermoplastic packaging film containing 15% TiO₂ having a thickness of about 0.75 milli-inch. The Bemis TiO₂ UV-protective thermoplastic film is available from Bemis located at Terra Haute, Ind. under the trade designation C22-9573. The process for sample preparation and handling was carried out as discussed above except that light impermeable folders having windows with no film covering the window opening are replaced with light impermeable folders with the window opening covered with C07-9225 film. The C07-9225 film is a medium density polyethylene extruded film available from Bemis located at Terra Haute, Ind. The samples wherein the window of the light impermeable folder is covered with the C07-9225 film are referred to as the control. The comparison data for the towel products wrapped in the C22-9573 UV-protective thermoplastic packaging film and wrapped in the C07-9225 film is provided in Table 12.

TABLE 12
Layered Towel Products

| Time | b-value | b-value |
|---|---|---|
| (hrs) | Control | Film |
| 0 | 3.54 | 3.54 |
| 1 | 6.41 | 5.03 |
| 2 | 7.51 | 5.61 |
| 3 | 8.31 | 6.19 |
| 4 | 8.94 | 6.37 |
| 5 | 9.49 | 6.74 |
| 6 | 9.87 | 7.11 |
| 7 | 10.35 | 7.34 |
| 8 | 10.67 | 7.42 |

Stretchable UV-Protective Thermoplastic Packaging Film

Single-ply towel products were used to determine the effectiveness of a stretchable UV-protective thermoplastic packaging film. The towel product used was the single-ply three-layered towel product described above. The single-ply three-layered towel product tested were single rolls wrapped standard thermoplastic packaging film and packaged in cardboard packaging wherein the cardboard packaging is wrapped in a stretchable UV-protective thermoplastic packaging film compared to single rolls wrapped individually in standard thermoplastic packaging film and packaged in cardboard packaging wherein the cardboard packaging is wrapped in a standard thermoplastic packaging film. The UV-protective chemical that is embedded in the UV-protective thermoplastic packaging film is not in direct contact with the pulp fiber in the consumer product. Therefore, the UV-protective chemical is not transferred to towel product or to any surface that comes into contact with the towel product. Stretchable UV-protective thermoplastic packaging film may be any polyethylene based or similar mono-layer or multi-layered film produced which could exhibit stretch characteristics ranging from about 150 to about 850% of the original unstretched length of the UV-protective thermoplastic packaging film.

The single-ply three-layered towel product was unwound and the first six (6) sheets were discarded. Then ten (10) single sheets were torn off the roll of towel product. The ten (10) single sheets of the towel product are then stacked one on top of the other, forming a pad of ten (10) single sheets of towel product. Each pad was cut into quarter towel sheet size, thereby forming samples of quarter towel sheet size pads. Each pad was stapled along two opposing edges. Each sample of quarter towel sheet size pad was placed on a piece of packaging cardboard having the dimensions of 9 inches×18.75 inches. Each sample of quarter towel sheet size pad and piece of packaging cardboard were wrapped by 3 layers of the stretchable UV-protective thermoplastic packaging film. The UV-protective thermoplastic packaging film was elongated about 250% in the MD direction during application. This stretched position was maintained during the trial. The stretchable UV-protective thermoplastic packaging film sample #1, K-C 3124, is low density polyethylene film available from Presto, located at Appleton, Wis. The stretchable UV-protective thermoplastic packaging film sample #1 contains between about 3% and about 3.5% TiO₂. The stretchable UV-protective thermoplastic packaging film sample #1 was fastened to itself by Scotch® brand tape, commercially available from the 3M, located at St. Paul, Minn. (but it is understood that any transparent tape would be acceptable). The stretchable UV-protective thermoplastic packaging film sample #1 has a gauge of about 70. The UV-protective thermoplastic packaging film sample #2 is a low density polyethylene film available under a trade designation KC 3125 from Presto, located at Appleton, Wis. The stretchable UV-protective thermoplastic packaging film sample #2 contains up to about 4% of an UV absorber. The stretchable UV-protective thermoplastic packaging film sample #2 was fastened to itself by Scotch® brand tape, commercially available from the 3M, located at St. Paul, Minn. The stretchable UV-protective thermoplastic packaging film sample #2 has a gauge of about 70.

Each light impermeable folder sample was labeled with the number of hours of the predetermined exposure period to UV light having wavelengths between about 300 and about 400 nm. The light source of the UV light cabinet is operated 20 minutes before the samples were placed within the UV light cabinet, thereby allowing the temperature within the UV light cabinet to equilibrate. The samples of quarter towel sheet size pads and attached piece of packaging cardboard were placed into a UV light cabinet, equipped with a light source comprising eight (8) Sylvania F40/350 BL bulbs (40 watts each). The UV light cabinet simulates accelerated exposure to filtered sunlight through window glass and fluorescent lighting. Each sample of quarter towel sheet size pads were laid onto each of the shelves, such that the entire quarter towel size pad is fully exposed to the light source. The UV light cabinet was described above. The samples of quarter towel sheet size pads were exposed to the UV light in the UV light cabinet for up to a total of 8 hours.

Brightness values and b-values were measured of each sample using the Technibrite Micro TB-1C instrument shortly after its removal from the UV light cabinet. The samples of quarter towel sheet size pads were removed from the pieces of packaging cardboard. Each sample of quarter towel sheet size pads were placed one at a time into the Technibrite Micro TB-1C instrument wherein the brightness value and the b-value were measured.

The predetermined exposure time for the samples of quarter towel sheet size pads were 0 hour and 8 hour for UV-protective thermoplastic packaging film sample #1. The predetermined exposure times for the samples of quarter towel sheet size pads varied from 0 hour, 1 hour, 2 hours, 3 hours, 4 hours, 5 hours, and 6 hours for UV-protective thermoplastic packaging film sample #2. Each hour of exposure in the UV light cabinet corresponds to approximately one month of exposure in an office environment. The UV-protective thermoplastic packaging film used maintained its relative clearness during the exposure in the UV light cabinet, showing no discoloration.

The test results for the single-ply three-layered towel product wrapped in the stretchable UV-protective thermoplastic packaging film sample #1 is provided in Table 13.

TABLE 13

| Time (h) | Brightness | B-Value |
|---|---|---|
| 0 | 81.61 | 3.66 |
| 8 | 80.88 | 3.89 |

The test results for the single-ply three-layered towel product wrapped in the stretchable UV-protective thermoplastic packaging film sample #2 is provided in Table 14.

TABLE 14

| Time (h) | B-value | Brightness |
|---|---|---|
| 0 | 3.56 | 82.09 |
| 1 | 5.08 | 77.98 |
| 2 | 6.07 | 75.98 |
| 3 | 6.2 | 75.8 |
| 4 | 6.67 | 74.95 |
| 5 | 6.81 | 74.74 |
| 6 | 6.86 | 74.81 |

As various changes could be made in the above constructions without departing from the scope of the invention, it is intended that all matter contained in the above description or shown in the accompanying drawings shall be interpreted as illustrative and not in a limiting sense.

We claim:

1. A consumer product packaging system comprising at least one consumer product wrapped in an UV-protective thermoplastic packaging film, at least one of the consumer product wrapped in the UV-protective thermoplastic packaging film having a brightness value wherein the brightness value of the consumer product changes about 5 percent or less during an exposure to light for a period of about 12 months or more.

2. The consumer product packaging system of claim 1, wherein the consumer product has a b-value that changes about 20 percent or less during an exposure to light for a period of about 12 months or more.

3. The consumer product packaging system of claim 1, wherein the consumer product has a b-value of about 8 or less after an exposure to light for period of about 12 months or more.

4. The consumer product packaging system of claim 1, wherein the UV-protective thermoplastic packaging film deflects and/or absorbs light having a wavelength between about 280 to about 435 nm.

5. The consumer product packaging system of claim 4, wherein the UV-protective thermoplastic packaging film deflects and/or absorbs about 90 percent or more of the light having wavelengths between about 280 to about 435 nm.

6. The consumer product packaging system of claim 1, wherein the UV-protective thermoplastic packaging film has a gauge of about 125 μm or less.

7. The consumer product packaging system of claim 1, wherein the UV-protective thermoplastic packaging film comprises polyester resins.

8. The consumer product packaging system of claim 1, wherein the UV-protective thermoplastic packaging film comprises at least one inorganic compound to provide light deflection and/or absorption.

9. The consumer product packaging system of claim 1, wherein the UV-protective thermoplastic packaging film comprises at least one organic compound to provide light deflection and/or absorption.

10. The consumer product packaging system of claim 1, wherein the consumer product comprises BCTMP.

11. The consumer product packaging system of claim 1, wherein the UV-protective thermoplastic packaging film is stretchable.

12. The consumer product packaging system of claim 11, wherein the UV-protective thermoplastic packaging film is capable of being elongated in the MD direction between about 50% to about 850%.

13. A consumer product packaging system comprising at least one consumer product wrapped in an UV-protective thermoplastic packaging film, the consumer product wrapped in the UV-protective thermoplastic packaging film having a b-value wherein the b-value of the consumer product changes about 20 percent or less during an exposure to light for a period of about 12 months or more.

14. The consumer product packaging system of claim 13, wherein the b-value of the consumer product is about 8 or less after an exposure to light for period of about 12 months or more.

15. The consumer product packaging system of claim 13, wherein the consumer product has a brightness value that changes about 5 percent or less during an exposure to light for a period of about 12 months or more.

16. The consumer product packaging system of claim 13, wherein the UV-protective thermoplastic packaging film deflects and/or absorbs light having a wavelength between about 280 to about 435 nm.

17. The consumer product packaging system of claim 16, wherein the UV-protective thermoplastic packaging film deflects and/or absorbs about 90 percent or more of the light having wavelengths between about 280 to about 435 nm.

18. The consumer product packaging system of claim 13, wherein the UV-protective thermoplastic packaging film has a gauge of about 125 μm or less.

19. The consumer product packaging system of claim 13, wherein the UV-protective thermoplastic packaging film comprises polyester resins.

20. The consumer product packaging system of claim 13, wherein the UV-protective thermoplastic packaging film comprises at least one inorganic compound to provide light deflection and/or absorption.

21. The consumer product packaging system of claim 13, wherein the UV-protective thermoplastic packaging film comprises at least one organic compound to provide light deflection and/or absorption.

22. The consumer product packaging system of claim 13, wherein the consumer product comprises BCTMP.

23. The consumer product packaging system of claim 13, wherein the UV-protective thermoplastic packaging film is stretchable.

24. The consumer product packaging system of claim 23, wherein the UV-protective thermoplastic packaging film is capable of being elongated in the MD direction between about 50% to about 850%.

25. A consumer product packaging system comprising at least one consumer product wrapped in a stretchable UV-protective thermoplastic packaging film, at least one of the consumer product wrapped in the stretchable UV-protective thermoplastic packaging film having a brightness value wherein the brightness value of the consumer product changes about 10 percent or less during an exposure to light for a period of about 8 months or more.

26. The consumer product packaging system of claim 25, wherein the consumer product has a b-value that changes about 100 percent or less during an exposure to light for a period of about 8 months or more.

27. The consumer product packaging system of claim 25, wherein the consumer product has a b-value of about 8 or less after an exposure to light for period of about 8 months or more.

28. The consumer product packaging system of claim 25, wherein the stretchable UV-protective thermoplastic packaging film deflects and/or absorbs light having a wavelength between about 280 to about 435 nm.

29. The consumer product packaging system of claim 25, wherein the stretchable UV-protective thermoplastic packaging film has a gauge of about 18 μm or less.

30. The consumer product packaging system of claim 25, wherein the stretchable UV-protective thermoplastic packaging film comprises at least one inorganic compound to provide light deflection and/or absorption.

31. The consumer product packaging system of claim 25, wherein the stretchable UV-protective thermoplastic packaging film comprises at least one organic compound to provide light deflection and/or absorption.

32. The consumer product packaging system of claim 25, wherein the stretchable UV-protective thermoplastic packaging film is capable of being elongated in the MD direction between about 50% to about 850%.

33. A consumer product packaging system comprising at least one consumer product wrapped in a stretchable UV-protective thermoplastic packaging film, at least one of the consumer product wrapped in the stretchable UV-protective thermoplastic packaging film having a b-value that changes about 100 percent or less during an exposure to light for a period of about 8 months or more.

34. The consumer product packaging system of claim 33, wherein the consumer product has a brightness value wherein the brightness value of the consumer product changes about 10 percent or less during an exposure to light for a period of about 8 months or more.

35. The consumer product packaging system of claim 33, wherein the b-value of the consumer product is about 8 or less after an exposure to light for period of about 8 months or more.

36. The consumer product packaging system of claim 33, wherein the stretchable UV-protective thermoplastic packaging film deflects and/or absorbs light having a wavelength between about 280 to about 435 nm.

37. The consumer product packaging system of claim 33, wherein the stretchable UV-protective thermoplastic packaging film has a gauge of about 18 μm or less.

38. The consumer product packaging system of claim 33, wherein the stretchable UV-protective thermoplastic packaging film comprises at least one inorganic compound to provide light deflection and/or absorption.

39. The consumer product packaging system of claim 33, wherein the stretchable UV-protective thermoplastic packaging film comprises at least one organic compound to provide light deflection and/or absorption.

40. The consumer product packaging system of claim 33, wherein the stretchable UV-protective thermoplastic packaging film is capable of being elongated in the MD direction between about 50% to about 850%.
